(19) United States
(12) Patent Application Publication
(10) Pub. No.: US 2025/0206386 A1
(43) Pub. Date: Jun. 26, 2025

(54) DASHBOARD CROSSBAR

(71) Applicant: GF Casting Solutions AG, Schaffhausen (CH)

(72) Inventors: Stephan PHILIPP, Gailingen (DE); Marc GUNIA, Schaffhausen (CH); Benedikt STARK, Stühlingen (DE); Steven TSCHEPE, Aach (DE)

(21) Appl. No.: 18/987,059

(22) Filed: Dec. 19, 2024

(30) Foreign Application Priority Data
Dec. 21, 2023 (EP) 23218945.6

(51) Int. Cl. B62D 25/14

(52) U.S. Cl. CPC B62D 25/145

(57) ABSTRACT

A dashboard crossbar of a motor vehicle, including a crossmember which extends transversely to a longitudinal direction of the motor vehicle from one A-pillar to an opposite A-pillar, the crossmember including end portions at two opposite ends thereof, and a support. The support is integrally connected to the end portions of the crossmember and protrudes towards a front of the vehicle in an arc, the crossmember and the support surrounding at least some regions of an extending panel. The crossmember, the support and the surrounded panel are formed integrally or together in one piece.

### CROSS REFERENCE TO RELATED APPLICATIONS

This application claims benefit to European Patent Application No. EP 23218945.6, filed on Dec. 21, 2023, which is hereby incorporated by reference herein.

### FIELD

The invention relates to a dashboard crossbar of a motor vehicle and to the production method thereof.

### BACKGROUND

In modern motor vehicles, a crossbar is generally provided as a supporting component for fastening various dashboard functions, which crossbar extends substantially horizontally from one A-pillar to the opposite A-pillar. Additional, separately formed components are fastened to the crossbar and have different functions such as a pedal receptacle, a support for the bulkhead or a fastening for an imaging unit of a heads-up display as well as other components. In order to optimize the stability of the crossbar, which extends over the entire width of the motor vehicle, and is fastened to the other components, between the driver and the front passenger, the crossbar also comprises a tunnel strut to the additional support which additionally divides the dashboard region.

DE 10 2022 116 803 B3 discloses an instrument panel which comprises a support frame, to which a plurality of additional functional components are fastened by means of additional, separately formed support parts. This has the disadvantage of being complex to assemble and, as a result of the configuration of the support frame, the support frame cannot help to dissipate forces in the event of a frontal impact.

DE 10 2013 212 878 A1 discloses a dashboard structural part which contains a dashboard crossbar on which a separately formed heads-up display housing comprising supports is arranged, and a separate shell-crossbar. This also has the disadvantage of having a plurality of individual parts which have to be assembled.

GB 2605613 A discloses a cross car beam which is produced in one piece, but from a glass-fibre-reinforced polymer, which means that the function of dissipating forces in the event of a frontal impact is also quite rare, and other functional components still have to be assembled on the cross car beam by additional retaining elements or supports.

The crossbars known from the prior art extend exclusively between the two A-pillars and have no surface extent in the longitudinal direction of the vehicle. Moreover, they are not suitable for absorbing forces in the event of a frontal impact or for dissipating forces to attachments, and fail as a result of buckling or rupture.

### SUMMARY

In an embodiment, the present disclosure provides a dashboard crossbar of a motor vehicle, comprising a crossmember which extends transversely to a longitudinal direction of the motor vehicle from one A-pillar to an opposite A-pillar, the crossmember comprising end portions at two opposite ends thereof, and a support. The support is integrally connected to the end portions of the crossmember and protrudes towards a front of the vehicle in an arc, the crossmember and the support surrounding at least some regions of an extending panel. The crossmember, the support and the surrounded panel are formed integrally or together in one piece.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a three-dimensional view of an upper face of a dashboard crossbar according to an embodiment of the present disclosure directed obliquely from a front towards a support;

FIG. 2 illustrates a three-dimensional view of the upper face of the dashboard crossbar according to an embodiment of the present disclosure directed obliquely from behind towards the crossmember;

FIG. 3 illustrates a three-dimensional view of the lower face of the dashboard crossbar according to an embodiment of the present disclosure directed obliquely from the front towards the support;

FIG. 4 illustrates a three-dimensional view of a lower face of the dashboard crossbar according to an embodiment of the present disclosure directed obliquely from the front towards the support;

FIG. 5 illustrates a three-dimensional view of the lower face of the dashboard crossbar according to an embodiment of the present disclosure directed obliquely from the front towards the support;

FIG. 6 illustrates a three-dimensional view of the dashboard crossbar according to an embodiment of the present disclosure installed in a schematic vehicle body; and

FIG. 7 shows a schematic casting tool during demoulding of the dashboard crossbar according to an embodiment of the present disclosure.

### DETAILED DESCRIPTION

In an embodiment, the present disclosure provides a dashboard crossbar and a method linked thereto for the production thereof, in which method the receiving portion for functional elements can be integrated, and the dashboard crossbar takes over the function of dissipating forces in the event of a frontal impact.

The foregoing is achieved in that the dashboard crossbar comprises a support which is integrally connected to the end portions of the crossmember and protrudes towards the front of the vehicle in an arc, the crossmember and the support surrounding at least some regions of a preferably horizontally extending panel, the crossmember, the support and the surrounded panel being formed integrally or together in one piece.

The dashboard crossbar according to an embodiment of the present disclosure of a motor vehicle contains a crossmember which extends transversely to the longitudinal direction of the motor vehicle, i.e. in the Y-direction, from one A-pillar to an opposite A-pillar of a motor vehicle. The longitudinal direction of the vehicle extends in the X-direction, the Y-direction extends transversely or at right angles horizontally to the longitudinal direction of the vehicle, and the Z-direction extends perpendicularly to the longitudinal direction of the vehicle or to the Y-direction, in other words downwards or upwards. The crossmember comprises end portions at the two opposite ends thereof. The dashboard crossbar according to the present disclosure comprises a support for the bulkhead, which support is integrally connected to the end portions of the crossmember and protrudes towards the front of the vehicle in an arc. The arc of the support preferably extends in the X-direction. The crossmember and the support surround at least some regions of a panel which extends preferably horizontally or in the Y-X-direction. At least some regions of the panel are framed by the crossmember and the support. The panel extends in the X and Y-directions inside a frame surrounding the panel at least in part, which frame is formed by the crossmember and the support. The crossmember, the support and the panel which is surrounded at least in part are formed integrally or together in one piece. As a result, there is no need for any joining process between the three elements.

Preferably, the dashboard crossbar according to the present disclosure is produced from a metal material. In combination with the configuration of the dashboard crossbar, this makes it possible for the dashboard crossbar to meet the crash requirements and to be able to dissipate the occurring forces without failing.

It is advantageous for the dashboard crossbar to be in the form of a thin-walled component and to have a wall thickness in the range of between 1 and 4 mm, preferably a wall thickness of between 1.5 and 3 mm. The wall thickness can vary over the course of the dashboard crossbar, which means that the wall thickness can be thicker, e.g. 3.5 mm, in some regions of the dashboard crossbar, and can be thinner, e.g. 1.5 mm, in some regions.

It is advantageous for the crossmember to be U-shaped or to have a U-shaped cross section in at least some portions. The crossmember which is integrally arranged on the dashboard crossbar preferably has a U-shape in the central portion and the end portions which are connected on both sides. At least one portion of the crossbar preferably extends in the form of a U-shaped profile. The end portions preferably have a closed cross section.

The U-shape or the U-shaped cross section of the crossmember is preferably open towards the bottom or in the negative Z-direction. This makes it possible to guide the cables for example in an organized and well-placed manner, and/or the crossmember can also be used as a guide channel for supply and discharge lines for a HVAC unit on the lower face of the dashboard crossbar or on the lower face of the crossmember. In addition, the U-shaped cross section of the crossmember leads to high rigidity of the component.

It has been found to be preferable when the arcuately extending support has a U-shaped cross section. The U-shape is preferably open towards the bottom or in the Z-direction. The U-shape is preferably used to guide an air duct and can be connected to a HVAC unit which is preferably fastened to the lower face of the dashboard crossbar. The U-shape can be used as part of an air duct, to which a corresponding air-duct cover, which extends along the U-shape, and thus forms a closed air duct, is fastened. Alternatively, a moulded air duct which is preferably made of plastics material can also be inserted in the U-shape, which duct preferably contains outlets for supplying air to the windscreen. The windscreen ventilation can thus optionally be integrated directly in the support by also providing for example ventilation slots in the support, which slots conduct the air out of a HVAC unit, through the U-shaped support, onto the windscreen. Of course, the U-shape or the U-shaped cross section of the support can also be used as a cable guide or for both purposes. It is advantageous for the HVAC unit to be arranged on the lower face of the dashboard crossbar or the panel and to be connected to an air duct extending on the lower face or in the U-shape of the support and/or the crossmember.

Furthermore, it has been shown to be advantageous when an optimum flow of forces is ensured in the vehicle body in the event of a frontal impact by means of the U-shape of the support and the integral attachment of the support to the crossmember or the end portions thereof.

It is advantageous for the panel to be integrally connected to one branch of the U-shaped cross sections of the crossmember and the support in each case.

Preferably, the panel has at least one opening to the instrument holder. It is advantageous for the opening to be formed in such a way that the instrument to be arranged is received directly therein.

It is advantageous for a channel to extend in the longitudinal direction of the vehicle at least in part between the apex of the arcuate support and the crossmember. The channel preferably extends along the X-direction and preferably runs through the middle of the dashboard crossbar. It is advantageous for the channel to connect to the U-shape of the support. This means that the airflow can be guided along the support into the centre of the dashboard crossbar, where a HVAC unit is preferably arranged. As already mentioned, this airflow takes place on the lower face of the dashboard crossbar. The channel additionally provides the advantage of additionally reinforcing the dashboard crossbar, as a result of which the dashboard crossbar is less likely to buckle in the event of a frontal impact.

The channel preferably extends in the panel. It has been found to be advantageous for the channel to be formed integrally in the panel. Moreover, it is also advantageous for the channel to extend over only a certain region of the panel.

It has been found to be an advantageous configuration when an integral steering column channel extends in the longitudinal direction of the vehicle from the crossmember to the support. It is advantageous for the steering column channel to be arranged between the end portion and the U-shaped part of the crossmember, and to extend in the X-direction. It has been found to be advantageous for the steering column channel to be formed in a U-shape which is open towards the bottom or in the negative Z-direction.

It is advantageous for the steering column channel to be U-shaped. As well as a steering column channel of this type being used for guidance through the steering column in the motor vehicle, the channel is also used to reinforce the dashboard crossbar according to the present disclosure. It has also been found to be advantageous for ribs to also be arranged in the U-shape.

The U-shape of the steering column channel is preferably open towards the bottom or in the Z-direction. As already mentioned, the advantageous embodiment can be attributed inter alia to the construction of a motor vehicle, since the steering column has to protrude through.

The crossmember preferably comprises, at the end portions thereof, a tubular portion having a closed cross section. It is advantageous for the tubular portion to be open throughout the Y-direction and to transition into the U-shaped portion of the crossmember. This means that for example cables can be stretched from one A-pillar to the other A-pillar. As an alternative embodiment, it has been found to be advantageous for the end portions to have a closed cross section or to have a tubular design and to be closed in the Y-direction, towards the central portion of the crossmember, which has a U-shape, and thus no continuous channel is formed from one A-pillar to the other A-pillar. Instead, a limiting member is arranged at the end of the closed cross section or of the tubular portion of the end portion in the region of transition to the U-shaped cross section. Preferably, the end portions each comprise an A-pillar connection on the outer ends thereof for connection to the A-pillars.

It has been found to be advantageous for the dashboard crossbar to be in the form of a light-metal die-cast part, which helps to reduce weight.

It should again be noted that, with the reference to an integrally arranged element on the dashboard crossbar according to the present disclosure, this is always to be understood as being formed in one piece with the dashboard crossbar according to the present disclosure or as belonging to a whole, and the dashboard crossbar according to the present disclosure is produced in one piece and contains the above-mentioned elements, and no separate parts are provided by any joining processes.

Advantages according to the present disclosure are also achieved by the dashboard crossbar being produced in the die-casting process. By means of the production of the dashboard crossbar, functions can be integrated in a single component. The component can also be formed with thin walls and still meets the requirements in terms of rigidity and the crash requirements.

It is advantageous for the casting tool used in the die-casting process to be opened in the X-Z-direction or obliquely to the longitudinal direction X of the motor vehicle in order to demould the dashboard crossbar.

All the possible configurations can be freely combined with one another and, in order to avoid repetition, the features of the device can also automatically relate to the method and vice versa.

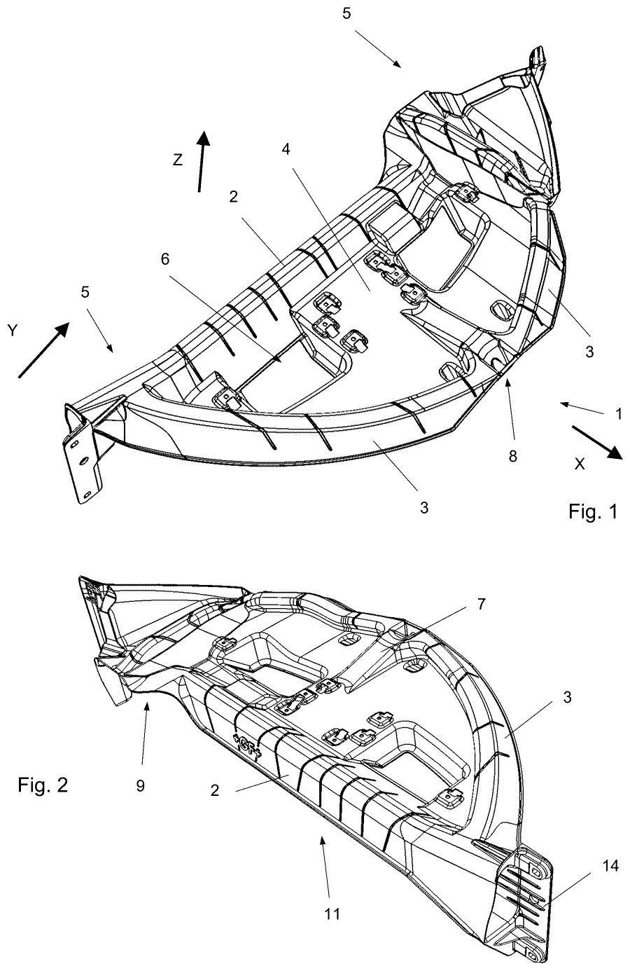

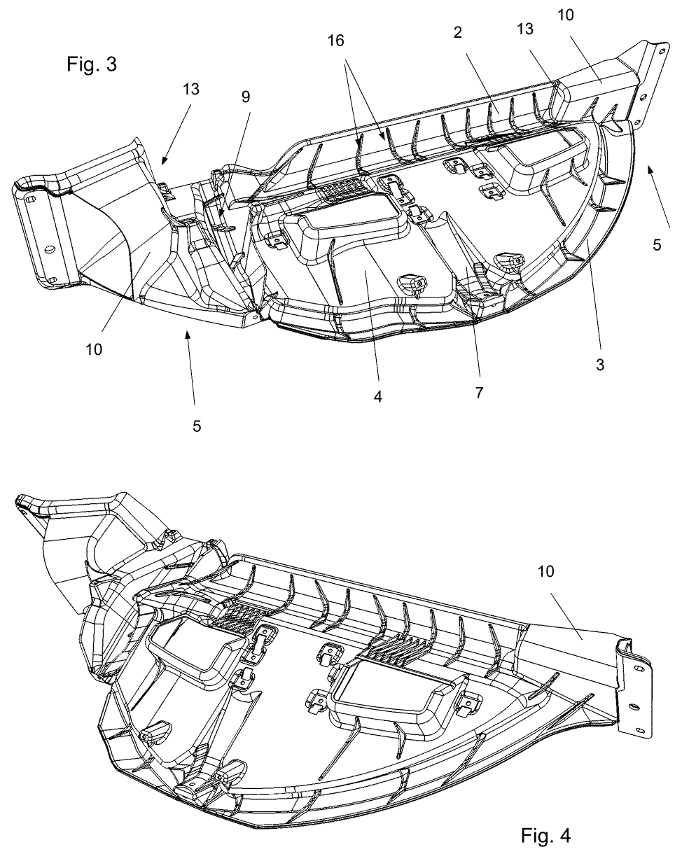

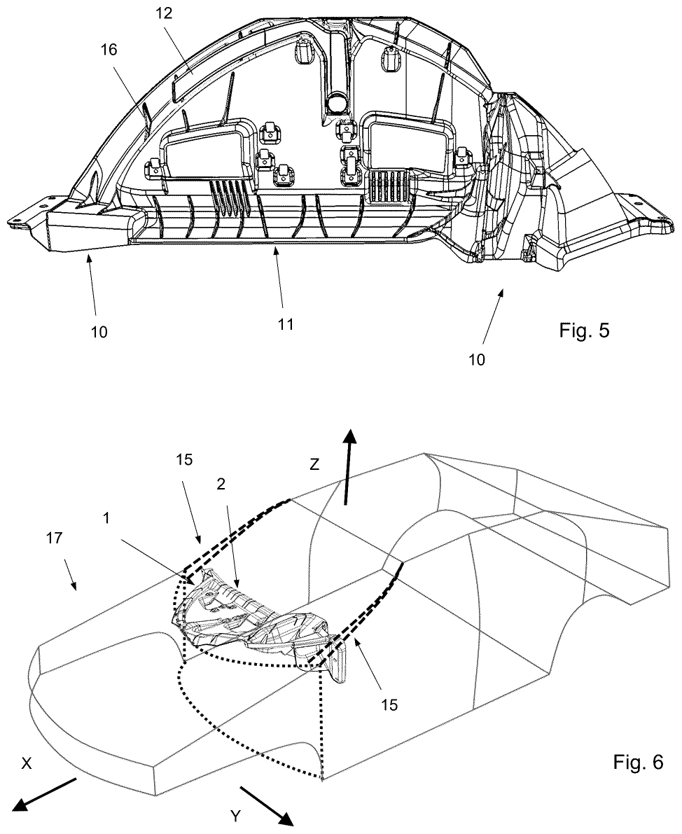

FIG. 1 is a three-dimensional view of the upper face of a dashboard crossbar 1 according to the present disclosure of a motor vehicle. The dashboard crossbar 1 contains a crossmember 2, which can be seen more clearly in FIG. 2. The crossmember 2 extends in the Y-direction transversely to the longitudinal direction X of the vehicle, from one A-pillar 15 to the opposite A-pillar 15 of a motor vehicle, which can also be clearly seen from FIG. 6. The crossmember 2 comprises end portions 5 at the two opposite ends thereof, said end portions being able to have different designs, as is the case in the embodiment shown. In addition, the dashboard crossbar 1 contains a support 3 which is integrally connected to the end portions 5 of the crossmember 2. The support 3 extends in an arc towards the front of the vehicle 17 or in the X-direction. Wherein the apex 8 of the arcuate support 3 forms the outermost point in the X-direction of the support 3 and integrally connects the ends of the support 3 to the crossmember 2 or the end portions 5. The crossmember 2 and the support 3 surround at least some regions of a panel 4 arranged therebetween. The panel 4 framed in part, the support 3 and the crossmember 2 are formed integrally or together in one piece. The panel 4, the support 3 and the crossmember 2 thus form a whole. Wherein the dashboard crossbar 1 according to the present disclosure is produced from one material, preferably a metal material, particularly preferably from a light metal. In addition, the dashboard crossbar 1 is produced in a mould. The crossmember 2 has a U-shaped cross section in at least some portions, preferably in the central portion 11, which cross section is open towards the bottom or in the negative Z-direction. This can be clearly seen from FIG. 3-5, in which the lower face of the dashboard crossbar 1 according to the present disclosure is shown. The portion in the form of a U-shaped profile in the crossmember 2 can preferably be used as a cable guide and/or to form a ventilation duct. Preferably, ribs 16 are also arranged in the U-shaped cross section of the crossmember 2 for additional reinforcement. The support 3 preferably also has a U-shaped cross section which is open towards the bottom, in which cables can be inserted, and/or the U-shape can be used as part of a ventilation duct. FIG. 5 shows the use of the U-shape of the support 3 as a ventilation duct in which a moulded ventilation duct 12 which is preferably made of plastics material is inserted in the U-shape which is open towards the bottom. Alternatively, the ventilation duct can also be formed with a duct cover in which the U-shape is covered. Preferably, a HVAC unit is arranged on the lower face of the dashboard crossbar 1, which unit is then connected to the ventilation duct. It is then possible to make slits in the outer face of the U-shaped support 3 which make it possible to supply air to the windscreen. It is advantageous for at least one opening, preferably for arranging instruments such as an imaging unit of a heads-up display or other displace devices, to be provided in the panel 4. It has also been found to be advantageous for a channel 7 to extend between the apex 8 of the arcuate support 3 and the crossmember 2. The channel 7 runs along the X-direction and preferably connects to the U-shape of the support 3. This allows a continuously extending channel which transitions from the U-shape of the support into the channel 7 and thus, as in FIG. 6, a possible ventilation duct to the HVAC unit, which is preferably arranged on the lower face of the dashboard crossbar. The channel 7 extends in the panel 4 or is formed as an elongate depression in the lower face of the dashboard crossbar 1, and on the upper face by a protruding projection. Wherein the channel 7 can extend through the panel 4 in part, as shown, or through the entire panel 6. The channel 7 also increases the rigidity of the dashboard crossbar 1 according to the present disclosure. Furthermore, it is advantageous for a steering column channel 9 to extend in the X-direction starting from the crossmember 2 as far as the support 3. The steering column channel 9 is U-shaped and is open towards the bottom or in the Z-direction, and the steering column can protrude therethrough. In addition, the steering column channel 9 in turn forms a reinforcement in the dashboard crossbar 1. In this case as well, ribs 16 can preferably be arranged in the U-shaped cross section. It can clearly be seen from FIG. 1-5 that the dashboard crossbar 1 is a thin-walled component, in other words the wall thickness is in the range of between 1 to 4 mm. The two end portions 5 on the crossmember 2 preferably comprise, as can be seen in the drawings, a tubular portion 10, wherein in this portion, the cross section has a closed shape. The tubular portion 10 is connected to the central portion of the crossmember 2, which has a U-shaped cross section, which can clearly be seen in FIG. 3. The portions do not have to be directly connected to one another, as on the other side of the steering column channel 9, they can also project therebetween. The tubular portions 10 are preferably conical on the end portion so that demoulding is possible. In the embodiment shown, the tubular portion 10 of the crossmember 2 comprises a limiting member 13, as a result of which there is no longer a continuous channel from the A-pillar to the opposite A-pillar 15. The limiting member 13 can of course also be omitted, which results in a continuous channel between the A-pillars 15. A-pillar connections 14 are arranged at the outer ends of the end portions 5 of the crossmember 2, to which the dashboard crossbar 1 is fastened at the A-pillars 15. The dashboard crossbar 1 can thus be joined to the A-pillars 15 of the body.

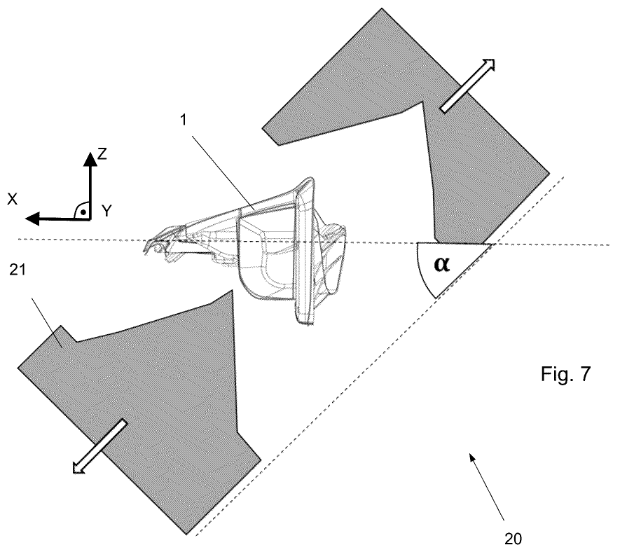

FIG. 7 shows a schematic casting tool 20 during the demoulding of the dashboard crossbar 1 according to the present disclosure. The main demoulding direction of the two tool halves 21 extends in the X-Z-direction.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Dashboard crossbar
2 crossmember
3 support
4 panel
5 end portion
6 opening
7 channel
8 apex
9 steering column channel
10 tubular portion of the end portion
11 central portion of the crossmember
12 ventilation duct
13 limiting member
14 A-pillar connection
15 A-pillar
16 rib
17 front of the vehicle
20 casting tool
21 tool half
X longitudinal direction of the vehicle
Y transversely to the longitudinal direction of the vehicle or at right angles horizontally to the longitudinal direction of the vehicle
Z perpendicularly to the longitudinal direction of the vehicle

1. A dashboard crossbar of a motor vehicle, comprising:
a crossmember which extends transversely to a longitudinal direction of the motor vehicle from one A-pillar to an opposite A-pillar, the crossmember comprising end portions at two opposite ends thereof; and
a support which is integrally connected to the end portions of the crossmember and protrudes towards a front of the vehicle in an arc, the crossmember and the support surrounding at least some regions of an extending panel, the crossmember, the support and the surrounded panel being formed integrally or together in one piece.

2. The dashboard crossbar according to claim 1, wherein the dashboard crossbar is produced from a metal material.

3. The dashboard crossbar according to claim 1, wherein the crossmember has a U-shaped cross section at least in some portions.

4. The dashboard crossbar according to claim 3, wherein the U-shaped cross section of the cross member is open towards a bottom.

5. The dashboard crossbar according to claim 1, wherein the support has a U-shaped cross section.

6. The dashboard crossbar according to claim 1, wherein the panel has at least one opening.

7. The dashboard crossbar according to claim 1, wherein, in the longitudinal direction of the vehicle, a channel extends at least in part between an apex of the support and the crossmember.

8. The dashboard crossbar according to claim 7, wherein the channel extends in the panel.

9. The dashboard crossbar according to claim 1, wherein, in the longitudinal direction of the vehicle, a steering column channel extends from the crossmember towards the support.

10. The dashboard crossbar according to claim 8, wherein the steering column channel has a U-shaped construction.

11. The dashboard crossbar according to claim 8, wherein the U-shape of the steering column channel is open towards a bottom.

12. The dashboard crossbar according to claim 1, wherein the crossmember comprises, on the end portions thereof, a tubular portion having a closed cross section.

13. The dashboard crossbar according to claim 1, wherein the dashboard crossbar is in a form of a light-metal die-cast part.

14. A method for producing the dashboard crossbar according to claim 1, comprising producing the dashboard crossbar in a die-casting process.

15. The method according to claim 14, wherein the casting tool used in the die-casting process is opened in an X-Z-direction or obliquely to the longitudinal direction of the motor vehicle in order to demould the dashboard crossbar.
